(19) United States
(12) Patent Application Publication
(10) Pub. No.: US 2017/0142946 A1
(43) Pub. Date: May 25, 2017

(54) Paddle With an Extendable and Retractable Speark

(71) Applicant: Brett Lockwood, Salt Lake City, UT (US)

(72) Inventor: Brett Lockwood, Salt Lake City, UT (US)

(21) Appl. No.: 15/346,558

(22) Filed: Nov. 8, 2016

Related U.S. Application Data
(60) Provisional application No. 62/259,452, filed on Nov. 24, 2015.

(51) Int. Cl. A01K 81/04; B63H 16/04

(52) U.S. Cl. CPC A01K 81/04; B63H 16/04

(57) ABSTRACT

The paddle of the present invention is a paddle having an extendable and retractable spear. The paddle of the present invention provides the customary utility of providing motion when used in connection with a water vessel. The present invention is particularly directed to an interior or exterior spear, which the user can selectably extend and retract.

### RELATED APPLICATIONS

This application claims priority to U.S. Provisional Patent Application Ser. No. 62/259,452, filed Nov. 24, 2015, entitled Paddle with an Extendable and Retractable Spear.

### BACKGROUND

### Field of the Invention

The present invention is directed to a unique paddle including a spear. In particular, the spear can be selectively extended and retracted for the convenience and use of the user.

### BRIEF DESCRIPTION OF THE DRAWINGS

The accompanying drawings, which are included as illustrative only, provide a further disclosure and understanding of the present invention. These drawings are incorporated and constitute a part of the disclosure and specification illustrating representative embodiments of the invention, and when taken together with the written description serve to explain the principles of the invention and provide an enabling disclosure:

In the drawings:

FIG. 1 illustrates generally a paddle and its external component parts;

FIG. 2 illustrates one embodiment of an internal extendible and retractable rod member;

FIG. 3 illustrates a kick-back angle between the paddle shaft and blade;

FIG. 4 illustrates the deployable and retractable interior rod member in a retracted position adjacent a face of the paddle blade; and

FIG. 5 illustrates the deployable and retractable rod member in a deployed position extending beyond the tip or edge of the paddle blade.

### DETAILED DESCRIPTION OF THE PREFERRED EMBODIMENTS

The following detailed description is merely illustrative of the nature of the present invention, and is not intended to limit the scope of the present invention to the details of the particular described embodiments. As used herein, the terms “representative” or “illustrative” or “embodiment” mean merely a representative application of the present invention. Additional and equivalent implementations of the concepts of the present invention will be apparent to one of ordinary skill in the art. There is no intention for the scope for the present invention to be limited or bound by the illustrative embodiments set forth herein.

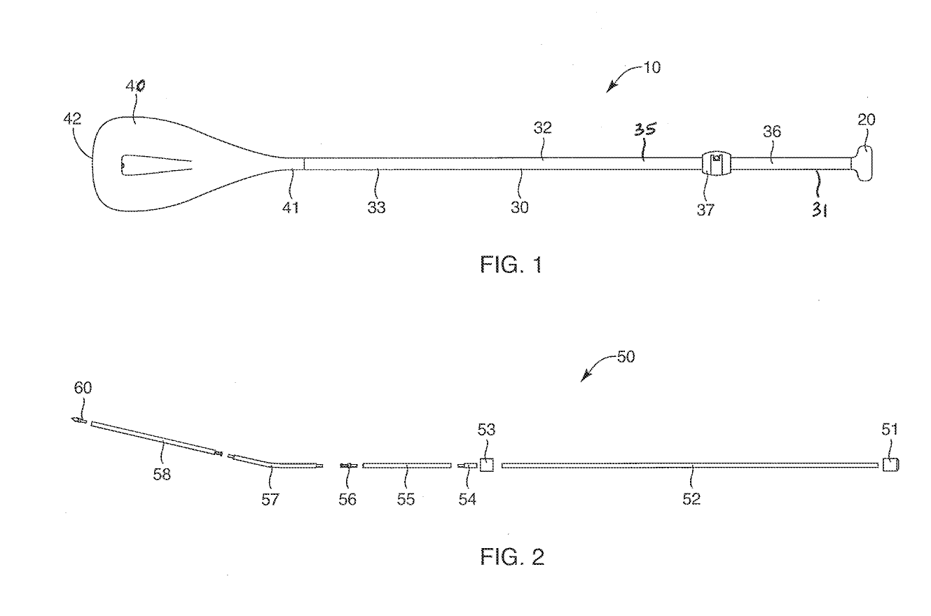

Detailed reference will now be made to illustrative embodiments of the present invention as set forth hereafter and in FIGS. 1-5.

As shown in FIG. 1, a paddle 10 is the subject of the present invention. Paddles commonly comprise a grip 20, a shaft 30, and a blade 40. The grip 20 may be any conventional grip providing the structure suitable to the user to satisfy any ergonomic or comfort features of the grip. The grip 20 is traditionally located on one end of the shaft 30.

Shaft 30 comprises three portions, namely, an upper shaft portion 31, and middle shaft portion 32, and a lower shaft portion 33. Traditionally, grip 20 is attached to upper shaft portion 31.

In one embodiment of the present invention, shaft 30 comprises a first shaft portion 35 and a second shaft portion 36. First shaft portion 35 and second shaft portion 36 is configured so as to have a telescoping nature. That is, one shaft portion may slide within the other shaft portion. For example, shaft portion 36 may slide in a telescoping manner within shaft portion 35. At a shaft juncture 37, a means 37 for fixing the relative positions of first shaft portion 35 and second shaft portion 36 may be disposed. Such means may comprise a selectively releasable clamping mechanism to fix the relative position of first shaft portion 35 with second shaft portion 36. This means will be referred to in this application as the positioning means 37.

Positioning means 37 can be any conventional screw-type tightener, clamping mechanism, or other known mechanism by which the position of telescoping members are held in a selectably fixed relationship one to another. The description of one embodiment of this invention are not dependent upon the nature of the positioning means but only on the ability of the user to cause one shaft portion to move in a telescoping fashion within another shaft portion as described below. As known by those skilled in the art, shaft 30 may be a straight shaft or a bent shaft. For purposes of this invention, a straight shaft is illustrated. One of skill in the art would understand how the concepts of the invention described in this patent can be adapted when used in connection with a bent shaft.

The blade 40 comprises a throat portion 41 defining a transition point between shaft 30 and blade 40. Blade 40 comprises a power face which contacts the water during a forward stroke and back face opposite the power face. For purposes of this invention, whether extendible and retractable rod member is used in conjunction with the power face or back face is only represented illustratively. Blade 40 also comprises an edge or tip 42 designating the extreme end of the paddle.

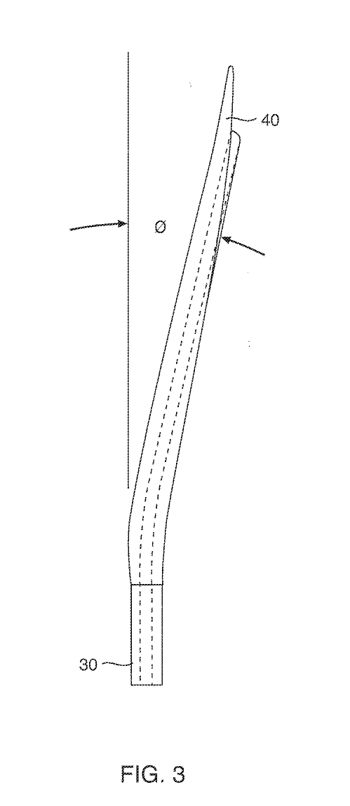

As shown in FIG. 2, one embodiment of the present paddle invention comprises a rod 50 slidable within shaft 30. One embodiment is illustrated in FIG. 2. Depicted are a handle/shaft adapter 51, a control rod 52, a shaft guide 53, an upper shaft adapter 54, and upper shaft 55, a cable adapter 56, a flexible cable 57, a lower shaft 58, and a tip 60. This configuration illustrates the present invention in which telescoping members of shaft 30 house components of rod 50 to effect deployment and retraction of rod 50 in a paddle including a kick-back angle Ø between shaft 30 and blade 40, see FIG. 3.

As depicted in FIG. 2, handle/shaft adapter 51 is configured to be fixed within second shaft portion 36 of paddle 10. Control rod 52 engages handle/shaft adapter 51. Shaft guide 53 is disposed within first shaft portion 35. Shaft guide 53 is connected to control rod 52 and slides within shaft 30. Upper shaft adapter 54 is attached to shaft guide 53. Upper shaft adapter acts as a host to upper shaft 55. The combination of control rod 52, shaft guide 53, upper shaft adapter 54, and upper shaft 55 is a rod member which can slide on the interior of shaft 30. Cable adapter 56 is attached to upper shaft 55. Cable adapter 56 allows the attachment of a flexible cable 57 because the embodiment illustrated in FIG. 2 employs a kick-back angle between shaft 30 and blade 40. Flexible cable 57 allows a force being exerted along control 52 to be transmitted at an angle within shaft 30 and blade 40. Lower shaft 58 is then attached to flexible cable 57. Lower shaft 58 acts as a host for tip 60.

Tip 60 may comprise any number of functional configurations, for example, if the device of the present invention is used as a defense mechanism against any undesirable water fowl or creatures, tip 60 may comprise a spear tip or an exploding spear tip that can be detonated by impact or some other conventional trigger means. If the paddle is used for collecting debris, tip 60 could comprise some type of gathering or grasping tip or even a small net. If the technology of the present invention is used for sport fishing, tip 60 could be a detachable barbed spear tip with an attached line, the tip being detachable or releasable such that when a barbed tip penetrates a fish and is lodged therein, the tip releases or breaks away but remains tethered by a line held by the user or the paddle. In any event, tip 60 is selectively removable and interchangeable depending upon the desired use and tip configuration.

The illustrative drawings of this application show a pointed spear tip, which could be used for a number of applications.

FIG. 3 depicts an angle Ø or a kick-back angle between the axis of shaft 30 and the plane of blade 40. A kick-back angle can be advantageous for paddling.

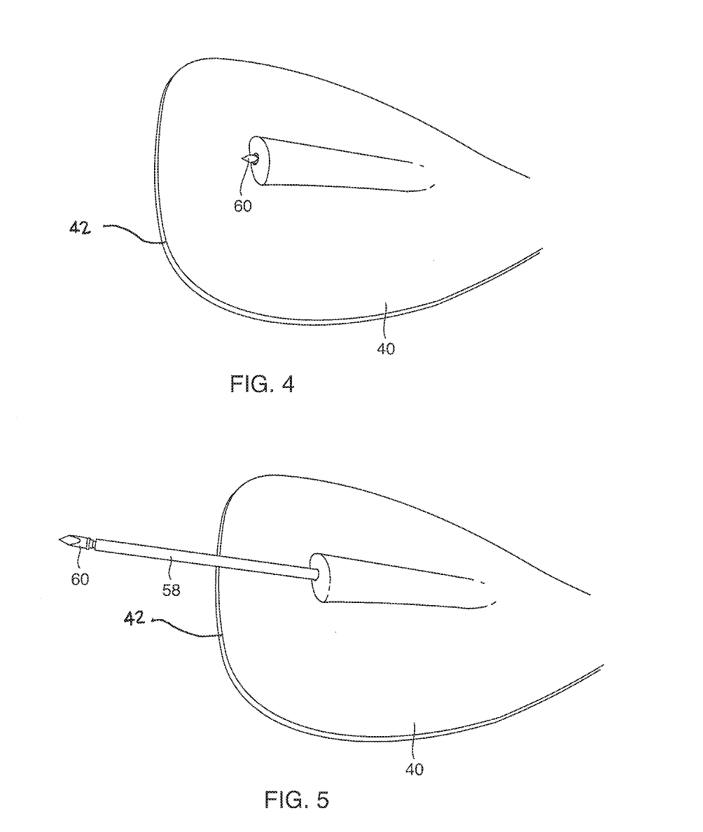

As shown in FIG. 2, members 51 through 58 provide one embodiment of rod 50 contained within shaft 30 which can be deployed and retracted using a telescoping configuration of the paddle. As further illustrated in FIGS. 3, 4, and 5, an opening on a face of paddle 40 acts a host to lower shaft 58 as rod 50 extends and retracts through the face of blade 40. As shown in FIG. 4, rod 50 with tip 60 resides in a retracted position adjacent a face of blade 40. When extended or employed, as shown in FIG. 5, lower shaft 58 extends outward beyond blade edge 42 allowing tip 60 to be utilized by the user. In a telescoping configuration of shaft 30, upper shaft 58 can be extended and retracted by a corresponding mechanical movement or change in relative position of first shaft portion 35 and second shaft portion 36 when positioning means 37 permits or facilitates such movement.

Tip 60 may be selectively added to or removed from upper shaft 58. The connection between tip 60 and upper shaft 58 can be by any conventional means such as a threaded connection, a bayonet connection, a friction connection, or any other customary or known structure which allows this selective attachment and detachment of tip 60 to upper shaft 58.

While the description above discloses a manual, mechanical means for deploying rod 50 housed within shaft 30 and blade 40 to an extended position and a retracted position, other embodiments are contemplated. For example, rather than having a push rod as shown in FIG. 2, an element of rod 50 could be attached to a compressible spring device which would allow rod 50 to be housed within shaft 30 in such a way that the spring mechanism is compressed and rod 50 is held within shaft 30 and blade 40 by an alternative positioning means 37 holding rod 50 stationary. Alternative positioning means 37 would comprise a release mechanism allowing spring-loaded rod 50 to move within shaft 30 under the force of the compressed spring as the spring extends rod 50 to protrude or extend beyond paddle edge 42. Rod 50 could be retracted by exerting force on tip 60 pushing rod 50 back into blade 40 and shaft 30 again compressing the spring mechanism and again allowing alternative positioning means 37 to hold rod 50 in place within shaft 30 and blade 40 until the next occasion upon which the user desired to deploy rod 50.

Another deploying means could include compressed gas which acts upon an alternative handle/shaft adapter 51 forcing movement of control rod 52 and its associated component parts to extend rod 50 out of blade 40 and beyond blade edge 42. Compressed gas canisters in various forms are commonly available and could be configured to be compatible with shaft 30 such that the user was able to control the compressed gas canister for selective deployment of rod 50.

A person of ordinary skill of the art that there may be other equivalent propulsion mechanisms whether they be manual, spring-actuated, pneumatic, electrical, hydraulic, or other cabling devices which would allow a force to be exerted upon rod 50 to cause it to be extended and which would allow rod 50 to also be retracted back within blade 40 and shaft 30.

An alternative embodiment could also include a rod 50 disposed exterior along a length of shaft 30. One such embodiment comprises a recessed channel or groove along the length of shaft 30. Rod 50 would be disposed in the groove along shaft 30 and traverse at least a portion of blade 40 when extended and retracted by any movement of rod 50 relative to shaft 30 and blade 40. Such movement of rod 50 along shaft 30 could be accomplished by a similar telescoping shaft configuration in which exterior rod 50 is retained in fixed relation to shaft portion 36 but allowed to slide in a channel or groove along shaft part 35, not shown in the Figures. In this way, an extendable and retractable rod member along the outside of shaft 30 could be part of an alternative embodiment.

1. A paddle apparatus comprising:
a shaft having a length with two ends;
a blade disposed at one end of the shaft;
a rod having a length; and
means for extending and retracting a portion of the length of the rod at the blade.

2. The paddle apparatus of claim 1 wherein the rod is disposed within a portion of the blade.

3. The paddle apparatus of claim 1 wherein the rod is disposed within a portion of the blade and within a portion of the shaft.

4. The paddle apparatus of claim 2 wherein the blade defines an aperture through which the rod extends and retracts.

5. The paddle apparatus of claim 4 wherein the blade further comprises a face, the aperture being on the face of the blade.

6. The paddle apparatus of claim 1 wherein the shaft comprises a first portion and a second portion disposed in a sliding configuration such that a length of the first portion slides adjacent a length of the second portion.

7. The paddle apparatus of claim 6 wherein the sliding configuration is a telescoping configuration.

8. The paddle apparatus of claim 6 wherein the length of the rod has a first and second end with a tip disposed at the first end adjacent the blade and the second end of the rod disposed within the second portion of the shaft.

9. The paddle apparatus of claim 8 wherein the means for extending and retracting a portion of the rod at the blade is accomplished when the portions of the shaft slide in opposite directions adjacent each other causing the tip of the rod to extend and retract.

10. The paddle apparatus of claim 8 wherein the tip is removable such that tips of various configurations can be disposed at the first end of the rod.

11. The paddle apparatus of claim 1 wherein the means for extending and retracting a portion of the rod at the blade comprises a spring mechanism disposed within or about the blade or shaft.

12. The paddle apparatus of claim 1 wherein the means for extending and retracting a portion of the rod at the blade comprises a compressed gas mechanism to extend the portion of the rod at the blade.

13. A combination paddle and harpoon apparatus comprising;
a shaft having a length with two ends;
a blade having a surface, the blade disposed at one end of the shaft;
a harpoon having length with a tip at a first end and a second end; and
means for extending and retracting the harpoon at the blade.

14. The combination paddle and harpoon apparatus of claim 13 wherein the tip of the harpoon is substantially disposed within the blade in a retracted position and when the harpoon is in an extended position the tip of the harpoon extends beyond the surface of the blade.

15. The combination paddle and harpoon apparatus of claim 13 wherein the blade surface defines an aperture through which the tip of the harpoon extends and retracts.

16. The combination paddle and harpoon apparatus of claim 13 wherein the shaft comprises a first portion and a second portion disposed in a sliding configuration such that a length of the first portion slides adjacent a length of the second portion.

17. The combination paddle and harpoon apparatus of claim 16 wherein the sliding configuration is a telescoping configuration.

18. The combination paddle and harpoon apparatus of claim 16 wherein the second end of the harpoon is disposed within the second portion of the shaft.

19. The combination paddle and harpoon apparatus of claim 18 wherein the means for extending and retracting the harpoon at the blade is accomplished when the portions of the shaft slide in opposite directions adjacent each other causing the tip of the harpoon to extend and retract at the blade.

20. The combination paddle and harpoon apparatus of claim 13 wherein the tip is removable allowing tips of different configurations to be attached to the first end of the harpoon.
